(19) United States
(12) Patent Application Publication
(10) Pub. No.: US 2007/0144175 A1
(43) Pub. Date: Jun. 28, 2007

(54) Turbocharger system

(76) Inventors: Thomas Michael Sopko JR., East Peoria, IL (US); Michael Vanderham, East Peoria, IL (US); Kent Allen Casey, Washington, IL (US); Brian D. Kuras, Metamora, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/646,416

(22) Filed: Dec. 28, 2006

Related U.S. Application Data
(63) Continuation-in-part of application No. 11/396,560, filed on Apr. 4, 2006.
Application No. 11/396,560 is a continuation of application No. 11/094,276, filed on Mar. 31, 2005, now Pat. No. 7,076,954.

(51) Int. Cl. F02D 23/00; F02B 33/44

(52) U.S. Cl. 60/605.1; 60/602; 60/612

(57) ABSTRACT

A system for controlling intake pressure of a combustion engine operably coupled to a power generation system includes at least one turbocharger operably coupled to the intake system of the combustion engine. The at least one turbocharger is configured to increase the intake pressure in the intake system of the combustion engine. A turbocharger controller is configured to compare actual and desired intake pressures and control operation of the at least one turbocharger based on the comparison such that the turbocharger supplies a desired intake pressure to the combustion engine.

This application is a continuation-in-part of U.S. patent application Ser. No. 11/396,560, filed Apr. 4, 2006, which is a continuation of U.S. patent application Ser. No. 11/094,276, filed Mar. 31, 2005, now U.S. Pat. No. 7,076,954. The entire contents of application Ser. No. 11/396,560 and U.S. Pat. No. 7,076,954 are incorporated herein by reference.

### TECHNICAL FIELD

The present disclosure relates generally to a turbocharger system and, more particularly, to an electric turbocharger system for use with a power generation system.

### BACKGROUND

A power generation system may used to generate power for either a stationary or a vehicular application. For example, an electric power generation system may used to provide electric power for a building or to provide power for propelling a vehicle and/or operating systems of a vehicle that require electric energy. In particular, a power generation system may be used to provide electric energy for what is sometimes referred to as a “hybrid vehicle” or “hybrid-electric vehicle,” which may include a combustion engine operably associated with an electric generator. The combustion engine generates mechanical energy and the electric generator converts at least a portion of the mechanical energy into electric energy. The electric energy may be used to operate one or more electric motors and/or other electrically-operated vehicle systems. For example, the one or more electric motors may be used to provide torque to driving members (e.g., wheels or ground engaging tracks) to propel the vehicle either independently or in combination with torque provided by the combustion engine. For a vehicle such as a work machine, for example, a wheel loader or a track-type tractor, the one or more electric motors may be used to propel the vehicle and the mechanical energy produced by the combustion engine and/or electric energy produced by the generator may be used to operate work implements via hydraulic actuators and/or hydraulic motors.

Regardless of whether the power generation system is used in a stationary or a vehicular application, it may often be desirable for the power generation system to be able to quickly and efficiently respond to sudden increases in load on the system. For example, in a power generation system used to provide electric energy for a building, if a sudden large increase in demand for electric energy occurs due, for example, to activation of one or more appliances requiring a substantial amount of electricity, a sudden large load will be placed on the power generation system. In vehicle applications, for example, in a work machine application, if the work machine is traveling across the ground and lifts a heavy load, such as a bucket filled with dirt and rock, a sudden large load will be placed on the power generation system due to the mechanical energy needed to lift the load. Such sudden large loads may cause the engine speed of the combustion engine to drop to an undesirably low speed (sometimes referred to as an “under-speed condition”), which may result in inefficient and/or undesirable operation of the combustion engine.

In order to counteract such large sudden loads on the electric power generation system, it may be desirable for the combustion engine to provide a responsive increase in torque to the power generation system. The rate at which the sudden electric and/or mechanical load may occur, however, may be essentially instantaneous relative to the ability of the combustion engine to respond to the sudden load. In particular, in order for the combustion engine to provide the desired responsive increase in torque, an increase in the amount of fuel and/or air supplied to the combustion engine must be increased. For example, more fuel may be delivered to the combustion engine to increase torque. In combination with the reduced engine speed that accompanies the sudden load, however, the resulting combustion may exhibit unacceptably high exhaust emission levels due to an overly rich air-to-fuel ratio (AFR). On the other hand, the intake pressure (e.g., the inlet manifold pressure) of the combustion engine may be increased in order to deliver more air to the combustion engine. If, however, the amount of fuel delivered to the engine is not also increased, an acceptable AFR will not likely be achieved, and there will not be a sufficient increase in torque to counteract the sudden load on the power generation system.

One technique for increasing the intake pressure of a combustion engine is the use of an exhaust gas-driven turbocharger. Such a turbocharger uses energy contained in the gases exhausted following combustion in a combustion engine to spin a turbine operably coupled to a compressor that, in turn, compresses air delivered to the intake system of the combustion engine. In this fashion, the intake pressure may be increased and more air may be delivered to the combustion engine, thereby increasing its output torque. Due to its exhaust gas-driven nature, however, a turbocharger may take an undesirably long time to respond to the need for increased output torque in response to a sudden change in load. In particular, since the turbocharger's compressor relies on the exhaust gas for driving its turbine, at low engine speeds that may occur as a result of a sudden load increase, the turbocharger's ability to provide a responsive increase in intake pressure may be undesirably slow.

One method of increasing the speed of response of a turbocharger is described in U.S. Pat. No. 4,901,530 (the '530 patent) issued to Kawamura on Feb. 20, 1990. The '530 patent describes a method for controlling a turbocharger with a rotary electric machine that detects the rotational speed of a motor vehicle's engine and an amount of accelerator pedal depression to monitor running conditions of the motor vehicle. A required boost pressure based on the running conditions is determined and if a difference between the required boost pressure and a present boost pressure is greater than a prescribed value, the device determines that the motor vehicle is running under conditions that require quick acceleration. The device then drives the rotary electric machine coupled to the rotatable shaft of the turbocharger to increase the speed of rotation of the turbocharger for a quick buildup of the boost pressure.

Although the device of the '530 patent may speed the build-up of boost pressure of the turbocharger, the determination that the motor vehicle is running under conditions that require quick acceleration are based on the detected rotational speed of a motor vehicle's engine and an amount of accelerator pedal depression. For power generation systems that experience sudden loads, however, detecting a motor's rotational speed and an accelerator pedal depression may not provide an effective determination basis and/or a quick enough response for increasing the rotation of the turbocharger's compressor in order to provide an increase in a combustion engine's torque output.

Increasingly, it is desirable to better control engine operating parameters in order to balance fuel efficiency, engine emissions control, and engine power requirements. To that end, some engines may employ such expedients as multiple turbochargers with associated cooling units, variable valve timing responsive to engine load with, for example, the capability of achieving very early or very late intake valve closing, and multi-stage fuel injection. Other expedients may include controlled recirculation of exhaust gases, including low pressure exhaust gas recirculation (low pressure EGR), and mixing fuel and air upstream of any pre-compression to create a more homogeneous charge. One or more of these expedients, along with turbocharger controlling, may assist in better controlling engine operating parameters and achieving a desired balance of fuel efficiency, engine emissions control, and engine power requirements.

Not only may the device of the '530 patent not provide an effective determination basis and/or a quick enough response for increasing the rotation of the turbocharger's compressor in order to provide an increase in a combustion engine's torque output, but also, the device of the '530 patent does not recognize the energy recovery capabilities, overall efficiency, and increased engine flexibility that may be achieved by employing additional features such as Miller Cycle operation, multiple stage pressurization of intake air, and variable valve timing, for example.

U.S. Pat. No. 3,257,797 issued to Lieberherr on Jun. 28, 1966 discloses, in FIG. 1 thereof, an engine including at least two stages of turbocharging (20, 16) with a cooling stage (22) between the compressor units of the two turbochargers and a second cooling stage (24) between the second compressor unit and the engine. Along with this, Lieberherr discloses a variable intake valve closing system and, while not using the term “Miller Cycle,” Lieberherr discloses using variable valve timing to close the inlet valve early, during the suction (i.e., intake) stroke of the piston, or late, during the compression stroke of the piston (which maintains the intake valve open for a portion of the compression stroke), in order to reduce the effective compression ratio (col. 6, lines 57-63). Additionally, Lieberherr discloses that reducing the effective compression ratio occurs with increasing engine load (col. 10, lines 17-24).

While the disclosure of the Lieberherr patent recognizes a number of important expedients, such as, dual stage turbocharging, late intake valve closing to maintain the intake valve open for a portion of the compression stroke to yield a reduced effective compression ratio at high engine loads, and variable valve timing, Leiberherr does not recognize the advantages of a turbocharger controller employed in connection with an electric machine operably coupled to the turbocharger.

U.S. Pat. No. 2,670,595 issued to Miller on Mar. 2, 1954. This Miller patent (U.S. Pat. No. 2,670,595), in FIG. 6, for example, discloses an engine including a turbocharger (52, 55) for pressurizing intake air and a cooler (58) between the turbocharger and the engine. Additionally, Miller discloses a variable intake valve closing system (FIG. 6; col. 9, line 23 through col. 10, line 21), and discloses a specific example of closing the intake valve early during the intake stroke at about 60° after top dead center (e.g., col. 6, lines 64-69). Miller also specifically discloses varying the effective compression ratio in consonance with load by holding the intake valve open during the entire intake stroke and during a part of the following compression stroke (col. 8, lines 14-23) (i.e., late closing of the intake valve).

While the disclosure of the Miller patent (U.S. Pat. No. 2,670,595) recognizes a number of important expedients, such as, pressurizing and cooling the intake air, variable intake valve timing, and both very early intake valve closing and late intake valve closing to vary the effective compression ratio in consonance with load, the Miller patent does not recognize the advantages of a turbocharger controller employed in connection with an electric machine operably coupled to the turbocharger.

U.S. Pat. No. 3,015,934 issued to Miller on Jan. 9, 1962. The Miller '934 patent discloses, in FIG. 1 thereof, an engine including a turbocharger (28) for pressurizing intake air and a cooler (36) between the turbocharger and the engine. Additionally, the Miller '934 patent discloses a variable intake valve closing system (FIG. 2), and discloses a specific example of late closing of the intake valve during the compression stroke, at 60 or 70 degrees before top dead center (col. 2, lines 31-33), reducing the effective compression ratio.

While the Miller '934 patent recognizes a number of important expedients, such as, pressurizing and cooling the intake air, variable valve timing, and maintaining the intake valve open during a majority portion of the compression stroke to as much as 60 or 70 degrees before top dead center in the compression stroke, the Miller '934 patent does not recognize the advantages of a turbocharger controller employed in connection with an electric machine operably coupled to the turbocharger.

The disclosed electric turbocharger system is directed to improvements in the foregoing technology.

### SUMMARY OF THE INVENTION

In one aspect, the present disclosure is directed to a system for controlling intake pressure of a combustion engine operably coupled to a power generation system. The system for controlling intake pressure includes at least one turbocharger operably coupled to an intake system of the engine. The at least one turbocharger is configured to increase the intake pressure in the intake system of the combustion engine. A turbocharger controller is configured to compare actual and desired intake pressures and to control operation of the at least one turbocharger such that the turbocharger supplies a desired intake pressure to the combustion engine.

In another aspect, the present disclosure is directed to a method of maintaining a desired air-to-fuel ratio supplied to a combustion engine operably coupled to a power generation system. The method includes determining a load on the power generation system. The method further includes controlling operation of at least one turbocharger via a turbocharger controller based on a comparison of actual and desired intake pressures and the load on the power generation system such that the desired air-to-fuel ratio supplied to the combustion engine is substantially maintained.

### BRIEF DESCRIPTION OF THE DRAWINGS

FIG. 1 is schematic block diagram of a power generation system according to a disclosed exemplary embodiment;

FIG. 2 is a schematic block diagram of a power generation system according to a disclosed exemplary embodiment;

FIG. 3 is a schematic block diagram of a control strategy for a turbocharger system according to a disclosed exemplary embodiment;

FIG. 4 illustrates an exemplary engine cylinder and related engine components;

FIG. 5 is a graph illustrating an exemplary intake valve actuation as a function of engine crank angle in accordance with the present disclosure; and

FIG. 6 is a diagrammatic view of an exemplary system including plural turbochargers.

### DETAILED DESCRIPTION

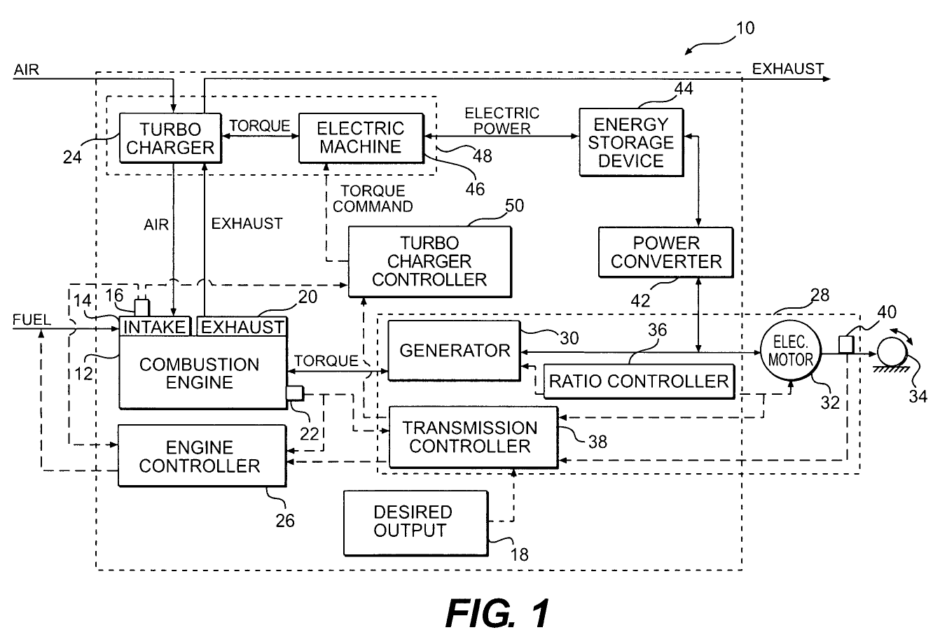

FIG. 1 schematically illustrates an exemplary power generation system 10, for example, an electric power generation system. Power generation system 10 may include one or more combustion engines 12 configured to generate mechanical energy. For example, combustion engine 12 may be an internal combustion engine configured to accept air and fuel via an intake system 14 including an intake manifold and to convert a mixture of the air and fuel into mechanical energy via combustion. Intake system 14 may include a pressure sensor 16 configured to emit a pressure signal representing the magnitude of pressure in the intake manifold. The mixture of air and fuel may be controlled such that its air-to-fuel ratio (AFR) is optimum for desired operation to, for example, improve fuel efficiency and/or reduce exhaust emissions. Further, the amount of air and/or fuel delivered to combustion engine 12 may be at least partially controlled via a signal indicative of a desired output 18, which may be provided, for example, via a throttle command, machine speed, electrical output, torque, and/or rimpull command. Once the air and fuel has undergone combustion, it is expelled from combustion engine 12 in the form of exhaust gas via an exhaust system 20.

Engine 10 may be, for example, a four cycle (i.e., four-stroke) internal combustion engine, and may include multiple cylinders. Engine 10 may be a compression ignited engine, such as a diesel engine, and may be fueled by any fuel generally used in a compression ignited engine, such as diesel fuel. Alternatively, engine 10 may be of the spark ignited type and may be fueled by gasoline, natural gas, methane, propane, or any other fuel generally used in spark ignited engines. Other combustion engines known to those having skill in the art are also contemplated.

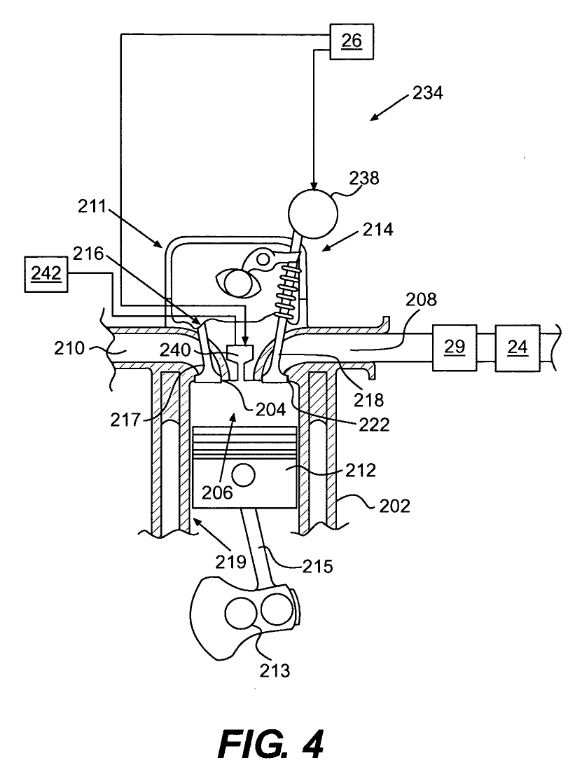

FIG. 4 diagrammatically illustrates certain operational details in connection with one cylinder of engine 12. The illustration in FIG. 4 and the following description may be representative of each of the cylinders of engine 12. Piston 212 may reciprocate within cylinder 219 mounted in engine block 202. Intake valve assembly 214 may be associated with cylinder head 211 and include an intake valve 218. A variable intake valve closing system 234 may include intake valve assembly 214 and a variable intake valve closing mechanism 238, controlled by engine controller 26. Under control of the variable intake valve closing system 234, intake valve 218 may selectively open to admit air and/or an air/fuel mixture to cylinder 219 through intake port 222, and may selectively close to capture air and/or an air/fuel mixture within cylinder 219. In addition, intake valve 218 may selectively open to admit a mixture of air and engine exhaust gases, or a mixture of air, fuel, and engine exhaust gases, and may selectively close to capture the mixture of air and engine exhaust gases, or the mixture of air, fuel, and engine exhaust gases, within cylinder 219.

Intake air and/or air/fuel mixture may flow toward intake port 222 and cylinder 219 via intake flow path 208 after having been compressed by at least one pre-compression unit, such as turbocharger 24, and then cooled by one or more cooling units, such as cooler 29. Similarly, a mixture of air and engine exhaust gases, or a mixture of air, fuel, and engine exhaust gases, may flow toward intake port 222 and cylinder 219 via intake flow path 208 after having been compressed by at least one pre-compression unit, such as turbocharger 24, and then cooled by one or more cooling units, such as cooler 29. Thus, cooled, pressurized air, or a mixture of cooled, pressurized air and fuel, or a mixture of cooled, pressurized air and engine exhaust gases, or a mixture of cooled, pressurized air, fuel, and engine exhaust gases, may enter a combustion chamber 206 partially defined by piston 212. Once combustion has occurred within combustion chamber 206, exhaust valve 217 of exhaust valve assembly 216 may selectively open to permit exhaust gases to flow from combustion chamber 206 through exhaust port 204 and into exhaust flow path 210, and may selectively close to inhibit the flow of gases through exhaust port 204. A suitable fuel may be admitted to combustion chamber 206. For example, in lieu of or in addition to any fuel that may be supplied to combustion chamber 206 along with intake air, fuel may be delivered directly to combustion chamber 206 via a fuel injector assembly 240 provided with fuel from a suitably fuel supply 242.

Summarizing, restating, and expanding on the description thus far, engine 12 may be a four-stroke, internal combustion engine including at least one combustion chamber 206 with at least one intake port 222 associated therewith. Piston 212 may partially define the chamber 206 and may be movable in a reciprocating manner within a cylinder 219 through a plurality of power cycles. Each power cycle may involve four strokes of the piston 212 resulting from two rotations of a crankshaft 213 driving connecting rod 215. The four strokes may include an intake stroke, a compression stroke, an expansion stroke (also known as a combustion stroke or a working stroke), and an exhaust stroke. Each power cycle may be aided by combustion taking place within the chamber 206.

Air may be compressed and cooled outside the chamber 206, for example by turbocharger 24 and cooler 29. Cooled, pressurized air may be supplied to the at least one intake port 222 associated with the chamber 206. During each cycle of the plurality of power cycles, the at least one intake port 222 may be opened, thereby allowing cooled, pressurized air to flow through the at least one intake port 222 and into the chamber 206 during at least a portion of the intake stroke. The at least one intake port 222 may be maintained open during the portion of the intake stroke and beyond the end of the intake stroke and into the compression stroke and during a majority portion of the compression stroke.

The term “majority portion of the compression stroke” is a term associated with Miller Cycle engine operation. A particular characteristic of the Miller Cycle is that the intake valve closes either early during the intake stroke, or late during the compression stroke. The term “majority portion of the compression stroke” refers particularly to a variety of late intake valve closing Miller Cycle in which the intake valve closes after remaining open for more than 90 crank angle degrees of the total 180 crank angle degrees in the compression stroke. In other words, the intake valve closing after a “majority portion of the compression stroke” refers to the intake valve closing after piston 212 travels through more than half of the compression stroke.

To further explain the term “majority portion of the compression stroke,” it is important to note that the beginning of the compression stroke is when the piston 212 is at its bottom dead center (BDC) position, after the piston 212 has completed its entire intake stroke. Piston 212 travels through a “majority portion of the compression stroke” when the crankshaft 213 rotates more than 90° after bottom dead center (greater than 90° ABDC) of the compression stroke. When the at least one intake port 222 is maintained open into the compression stroke and during a “majority portion of the compression stroke,” intake valve 218 does not close intake port 222 until more than 90° ABDC.

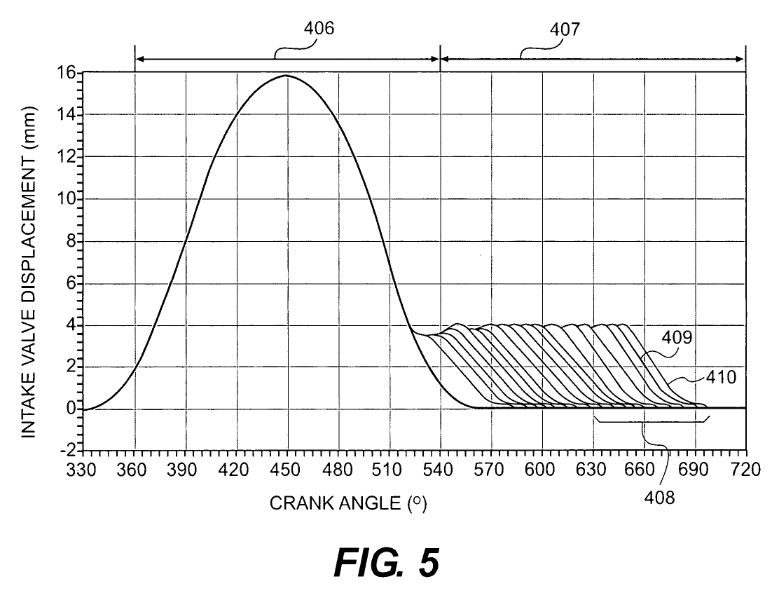

FIG. 5 graphically illustrates intake valve timing in accordance with exemplary disclosed embodiments. In connection with FIG. 5, it should be understood that 720 degrees represent two complete rotations of crankshaft 213 occurring during each four-stroke power cycle and that 0 degrees (not shown in FIG. 5) constitutes the beginning of the expansion stroke. Intake valve 218 (see FIG. 4) may begin to open at about 360° crank angle, that is, when the crankshaft 213 is at or near a top dead center (TDC) position of an intake stroke 406. The closing of the intake valve 218 may be selectively varied so as to close the intake port 222 at any crank angle position 407 in the compression stroke, ranging from BDC of the compression stroke (5400 in FIG. 5) to TDC of the compression stroke (720° in FIG. 5). FIG. 5 graphically illustrates various intake valve closing positions at 408, representing the intake valve 218 remaining open for a majority portion of compression stroke 407. Each of the intake valve displacement profiles associated with the valve closing positions 408 show the intake valve 218 held open for a majority portion of the compression stroke 407, that is, for the first half of the compression stroke 407 (in FIG. 212, from 540° to 630°) and a portion of the second half of the compression stroke 407 (in FIG. 5, greater than 630°).

After the at least one intake port 222 is maintained open, the at least one intake port 222 may be closed at a point during travel of the piston 212 to capture in the chamber 206 a cooled compressed charge comprising the cooled, pressurized air (and any fuel and/or recirculated exhaust gas introduced into the chamber 206 along with the air). Fuel may be controllably delivered into the chamber 206 after the cooled compressed air is captured within the chamber 206, and the fuel and air mixture may be ignited within the chamber 206. While fuel may be delivered to chamber 206 directly via fuel injector unit 240, it will be understood that fuel may be mixed with the intake air at some point outside chamber 206, e.g., upstream of turbocharger 24 so as to form a fuel/air mixture that may be compressed within turbocharger 24 and subsequently cooled by cooler 28 before entering chamber 206.

The variable intake valve closing system 234 may close the intake valve 218 at a first crank angle during one four stroke cycle of the piston 212, and at a second crank angle during another four stroke cycle of the piston 212, with the first crank angle being different from the second crank angle. Both the first crank angle and the second crank angle may occur after a majority portion of the compression stroke has occurred. For example, referring to FIG. 5, the respective closing crank angles represented by alternative curves 409 and 410 both occur after a majority portion of the compression stroke. In one example, during a given plurality of four stroke cycles, intake valve 218 (FIG. 4) may close along curve 409 in one cycle, and close along curve 410 in a succeeding cycle. The variable intake valve closing system 234 may permit delaying or retarding the closing of intake valve 218 to any extent into the compression stroke. For example, in one exemplary embodiment, the intake valve 218, and thus intake port 222, may be maintained open for at least 65% of the compression stroke (which is about 117° ABDC of the compression stroke). In other exemplary embodiments, the intake valve 218 and intake port 222 may be maintained open for at least 80% or 85% of the compression stroke (which is about 144° or 153° ABDC of the compression stroke). Maintaining the intake port 222 open for a majority portion of the compression stroke may occur, for example, during high load operation of the engine 12.

Engine controller 26 may be configured to control operation of the variable intake valve closing mechanism 238 and/or fuel injector assembly 240 based on one or more engine conditions, such as, engine speed, load, pressure, and/or temperature in order to achieve a desired engine performance. The controller 26 may be in the form of a single controlling unit or a plurality of units. Where the engine is a natural gas or gasoline engine, spark timing may be controlled by controller 26 in a fashion similar to fuel injector timing of a compression ignition engine.

Controllable delivery of fuel into the chamber 206 via fuel injector assembly 240 may include injecting a pilot injection of fuel and injecting a main injection of fuel. The pilot injection of fuel may commence when the crankshaft 213 is at about 675 crank angle degrees, that is, about 45° BTDC of the compression stroke. The main injection of fuel may begin when the crankshaft 213 is at about 71° crank angle degrees, that is, about 10° BTDC of the compression stroke and/or about 35° to 45° after commencement of the pilot injection. Generally, the pilot injection may commence when the crankshaft 213 is about 40° to 50° BTDC of the compression stroke and may last for about 10-15 degrees of crankshaft rotation. The main injection may commence when the crankshaft 213 is between about 10° BTDC of the compression stroke and about 12° ATDC of the expansion stroke. The main injection may last for about 20-45 crank angle degrees of rotation. The portion of fuel injected in the pilot injection may be about 10% of the total fuel injected in both the pilot and main injections.

Combustion engine 12 may include an engine sensor 22 configured to sense combustion engine speed and/or to produce an engine speed signal. Engine sensor 22 may include, for example, a magnetic pick-up sensor configured to produce a signal corresponding to the rotational speed of combustion engine 12. Engine sensor 22 may also be capable of determining speed, angular position, and/or direction of rotation of combustion engine 12's output shaft.

As noted above, turbocharger 24 may be configured to compress air prior to delivery to intake system 14 of combustion engine 12 for combustion. Turbocharger 24 may include a turbine operably coupled to exhaust system 20 such that energy in the exhaust gas may be converted into mechanical energy via rotation of the turbine. Turbocharger 24 may also include a compressor operably coupled to the turbine (e.g., via a shaft) and intake system 14 such that mechanical energy of the turbine may be imparted to the compressor, thereby rotating the compressor such that pressure in intake system 14 is increased. In this manner, more air and/or fuel may be delivered to combustion engine 12 such that combustion engine 12 may create more torque and/or power. Furthermore, power generation system 10 may include an engine controller 26 configured to regulate the amount of fuel and/or air delivered to combustion engine 12 such that a desired AFR may be maintained for combustion in order to achieve, for example, an optimum fuel efficiency and/or a minimum level of exhaust emissions.

Combustion engine 12 may be operably coupled to one or more transmissions via an output shaft. For example, in the exemplary embodiment depicted in FIG. 1, combustion engine 12 is operably coupled to electric transmission 28. Electric transmission 28 may be, for example, a continuously variable transmission (CVT) and may include a generator 30 configured to convert at least a portion of mechanical energy in the form of torque supplied by combustion engine 12 into electric energy. Electric transmission 28 may further include one or more electric motors 32 configured to provide torque to one or more driving members 34 (e.g., wheels or ground engaging tracks). Electric transmission 28 may include a ratio controller 36 and a transmission controller 38. Ratio controller 36 may be operably coupled to generator 30 and electric motor 32 and may be configured to control the ratio of a transmission output speed to a transmission input speed, which may be determined for example, via the output of engine sensor 22 and one or more transmission sensors 40. Transmission sensor 40 may be configured to generate a load signal indicating, for example, the load (e.g., a torque load) on electric transmission 28. Alternatively, the load on electric transmission 28 may be determined without transmission sensor 40, for example, by sensing electric load and/or by other methods known to a person having skill in the art. Transmission controller 38 may be operably coupled to ratio controller 36 and may be configured to receive signals from ratio controller 36 and communicate with engine controller 26, for example, as part of a predictive load management system. According to some embodiments, rather than being separate from transmission controller 38, ratio controller 36 may be integral with transmission controller 38. By virtue of combustion engine 12 being operably coupled solely to one or more generators 30, a vehicle using such a power generating system configuration may be propelled via torque supplied solely from one or more electric transmissions 28. Such a configuration is sometimes referred to as a “series hybrid” system.

Generator 30 may also be configured to supply electric energy to a power converter 42. Power converter 42 may be configured to convert electric energy into a form for use by electrically-powered components of power generating system 10 and/or any other devices operably coupled thereto that may be electrically-powered.

Power generating system 10 may also include an energy storage device 44, for example, one or more batteries, operably coupled to power converter 42. Energy storage device 44 may be configured to store energy in the form of electric energy for use by components of power generating system 10 and/or any other devices operably coupled thereto.

Power generating system 10 may include an electric machine 46 operably associated with energy storage device 44 and turbocharger 24. Electric machine 46 may include an electric motor configured to provide torque to turbocharger 24 in order to drive turbocharger 24's compressor and/or to supplement torque provided to turbocharger 24's compressor by turbocharger 24's turbine. Electric machine 46 may further include a generator configured to convert mechanical energy received from turbocharger 24's turbine into electric energy, which may, in turn, be stored in energy storage device 44. In combination, turbocharger 24 and electric machine 46 may serve to form a turbocharger system 48, which may be at least a portion of a turbocharger compounding system.

Power generating system 10 may further include a turbocharger controller 50, which may be configured to receive inputs in the form of an intake pressure signal from the intake sensor 16, and/or a load signal received from engine controller 26 and/or transmission controller 38. Turbocharger controller 50 may be operably coupled to electric machine 46 of turbocharger 48 and may be configured to control turbocharger 24. For example, turbocharger controller 50 may be configured to activate electric machine 46 to supply torque to turbocharger 24's compressor, activate electric machine 46's generator to slow turbocharger 24's compressor, and/or may open a wastegate to reduce the amount of exhaust gas driving turbocharger 24's turbine.

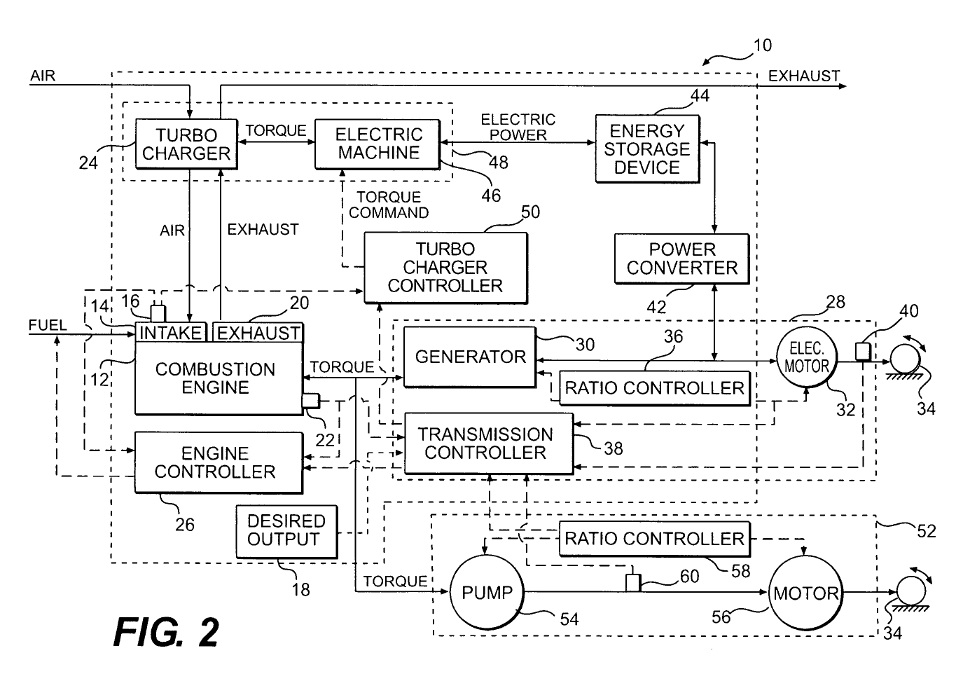

Referring to the exemplary embodiment schematically depicted in FIG. 2, combustion engine 12 may be operably coupled to both an electric transmission 28 and a second transmission, for example, a mechanical transmission 52 configured to provide torque to driving members 34 (e.g., wheels or ground engaging tracks) to propel a vehicle with energy provided by combustion engine 12. Mechanical transmission 52 may be a fixed or multi-ratio transmission or, for example, a mechanical CVT, such as a hydraulic CVT, including one or more pumps 54 and one or more motors 56, such as, for example, a variable displacement pump and a variable displacement motor driven by fluid received from pump 54. Mechanical transmission 52 may include a ratio controller 58 configured to alter displacement of pump 54 and/or motor 56 (i.e., when pump 54 is a variable displacement pump and/or when motor 56 is a variable displacement motor) to thereby control the output of mechanical transmission 52's motor 56, which may be operably coupled to driving members 34. Mechanical transmission 52 may also include one or more transmission sensors 60 configured to provide a load signal (e.g., a torque load signal). For example, transmission sensor 60 may include a resolver configured to measure, for example, a pressure differential between supply fluid fed to pump 54 and return fluid exiting motor 56. The pressure differential may be indicative of mechanical transmission 52's load.

In addition to being operably coupled to mechanical transmission 52, combustion engine 12 of the exemplary embodiment depicted in FIG. 2 may be operably coupled to electric transmission 28 in a manner at least similar to the embodiment depicted in FIG. 1. Generator 30 may be operably coupled to, for example, one of more electric motors 32, which may provide torque to driving members 34 of a vehicle. By virtue of combustion engine 12 being operably coupled to both electric transmission 28 and mechanical transmission 52, a vehicle using such a power generating system configuration may be propelled via torque supplied from electric transmission 28 and/or mechanical transmission 52. Such a configuration is sometimes referred to as a “parallel hybrid” system.

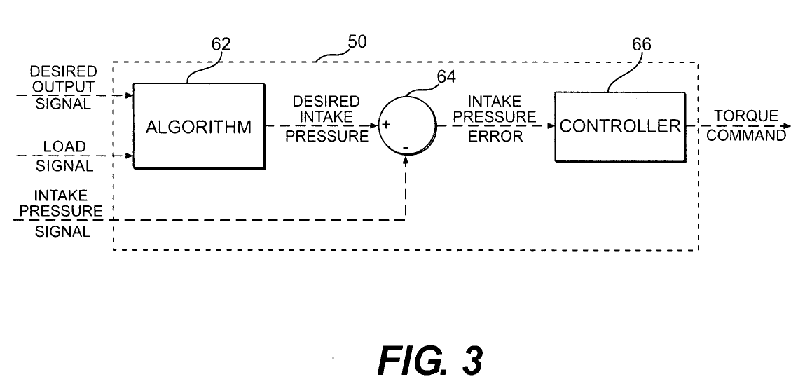

Referring FIG. 3, turbocharger controller 50 may include an algorithm 62 (e.g., a flexible gain scheduling algorithm) configured to receive inputs, such as a load signal (e.g., a transmission load signal). Algorithm 62 may be configured to determine a desired intake pressure based on a function of, for example, desired output signal 18 and the load signal. For example, an engine power load may be determined by algorithm 62 based a magnitude of the transmission load signal and/or a rate of change of the magnitude of the transmission load signal. Further, a desired AFR (e.g., an optimum AFR) may be selected by algorithm 62 based on the magnitude of the transmission load signal and/or a rate of change of the magnitude of the transmission load signal via, for example, one or more maps and/or equations loaded into a memory device of turbocharger controller 50. Further, the desired AFR may be used to determine a desired intake pressure in an at least similar manner.

Turbocharger controller 50 may include a comparator 64 configured to compare the desired intake pressure received from algorithm 62 and the intake pressure signal received from pressure sensor 16. Comparator 64 may generate an intake pressure error signal, and turbocharger controller 50 may further include a controller 66 (e.g., a proportional-integral-differential (PID) controller) configured to receive the intake pressure error signal and send an appropriate torque command signal to electric machine 46. Alternatively (or in addition), other control strategies such as proportional-integral control may be employed in controller 66.

Based on the torque command signal from turbocharger controller 50, if additional intake pressure is needed to achieve a desired intake pressure associated with a desired AFR to achieve a desired torque increase of combustion engine 12, electric machine 46 may provide torque (e.g., supplemental torque) to the compressor of turbocharger 24, thereby increasing the intake pressure to achieve the desired AFR. Alternatively, if a reduction in intake pressure is needed to achieve a desired intake pressure associated with a desired AFR to achieve a desired torque decrease of combustion engine 12, electric machine 46 may provide torque (e.g., a braking torque) to the compressor of turbocharger 24, thereby decreasing the intake pressure to achieve the desired AFR.

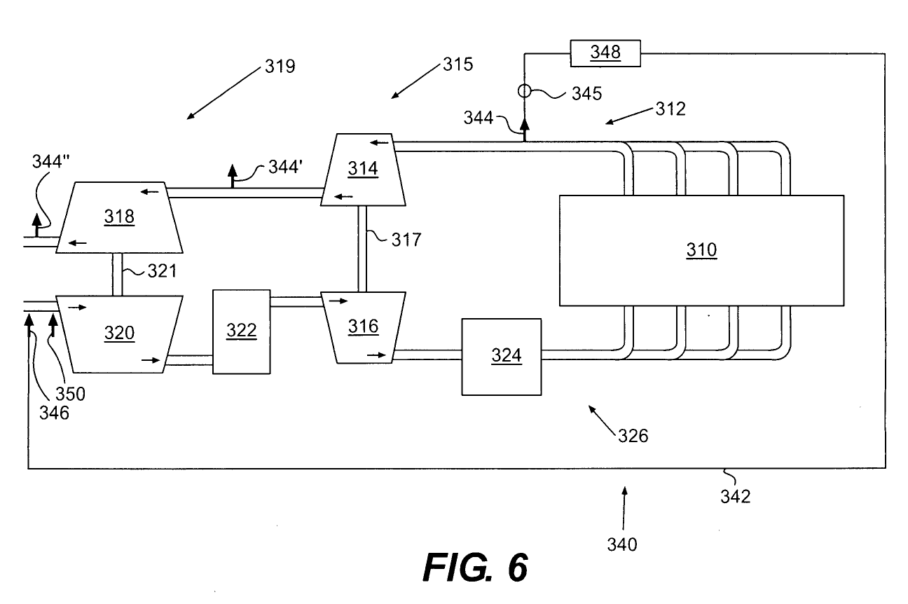

FIG. 6 illustrates an exemplary embodiment of an engine 310 (similar to engine 12 of FIG. 1 and having one or more engine cylinders and other components as shown in FIG. 4) which may employ a turbocharger controller with multiple stages of pressurization of engine intake air, for example by plural turbochargers. While the details of the turbocharger controller have been omitted from FIG. 6, it will be understood that they are substantially similar to those described in connection with the turbocharger controller in the embodiments of FIGS. 1-3. Differences in a turbocharger controller employed in connection with the embodiment of FIG. 6 relative to that employed in connection with the embodiments of FIGS. 1-3, may include an electric machine (similar to electric machine 46 illustrated in FIG. 1) associated with any one or more of the plural turbochargers. In other words, while the single turbocharger disclosed in connection with the embodiments of FIGS. 1-3 may have associated with it a single electric machine 46, it is possible to employ a similar electric machine, and its accompanying electronics, with any one or more (or even all) of the turbochargers in a multiple turbocharger system. In this way, energy may be recovered efficiently in such a multiple turbocharger system. FIG. 6 illustrates an exemplary multi-stage system for pressurizing engine intake air utilizing two turbochargers.

During operation of engine 310, exhaust gases may flow through exhaust system 312, first to a turbine 314 of a turbocharger 315 and then to a turbine 318 of a turbocharger 319. Intake air and or air/fuel mixture may flow through intake system 326, passing first through compressor 320 of turbocharger 319 and thereafter through compressor 316 of turbocharger 315. Compressor 316 may be driven by turbine 314 via shaft 317, while compressor 320 may be driven by turbine 318 via shaft 321. A cooling unit in the form of intercooler 322 may be positioned between compressor 320 and compressor 316 to cool air and/or air/fuel mixture pressurized by compressor 320 and thereby increase its density. A cooling unit in the form of aftercooler 324 may be positioned between compressor 316 and engine 310 to cool air and/or air/fuel mixture pressurized by compressor 316 and further increase the density of the air and/or fuel/air mixture.

Compressor 320 may compress intake air from ambient atmospheric pressure to approximately 2-3 atmospheres, for example. In doing so, the air may be heated from an ambient temperature of, for example, 68° F. up to approximately 313° F. Intercooler 322 may then cool the air to approximately 140° F. and increase its density. The compressed and cooled air may then enter compressor 316 and be compressed further to approximately 4-6 atmospheres, for example. After compression within compressor 316 raises temperature of the intake air once again, aftercooler 324 may reduce the temperature of the intake air to less than or equal to 200° F. Thus, intake air may be pressurized to at least 5 atmospheres, or even 6 atmospheres, and cooled to as low as 200° F. or below so as to produce pressurized air or a pressurized mixture of fuel and air which is subsequently captured within the combustion chambers in engine 310.

Referring still to the exemplary embodiment diagrammatically illustrated in FIG. 6, emissions control and fuel efficiency may be enhanced by employing various expedients. For example, a system for controllably recirculating a portion of the engine exhaust gases may be employed. While such a system may be recognized by different designations in the art, for purposes of simplifying this description, the term EGR (exhaust gas recirculation) will be employed. EGR system 340 may be configured to extract a portion of the engine exhaust gases from exhaust system 312, before conveying the exhaust gases through a suitable flowpath 342, and introducing the exhaust gases into the intake system 326.

In the exemplary embodiment of FIG. 6, exhaust gases may be extracted from exhaust system 312 at a relatively high pressure point, designated by arrow 344, between engine 310 and turbine 314, and introduced into the intake system at a relatively low pressure point, designated by arrow 346, upstream of compressor 320, resulting in a mixture in intake system 326 including air and recirculated exhaust gases. In such an arrangement, the turbochargers 319 and 315 compress the air and exhaust gas mixture and the intercooler 322 and aftercooler 324 cool the air and exhaust gas mixture before the cooled, compressed mixture is supplied to the combustion chamber of the engine 310 via an intake port. Extraction of exhaust gases may alternatively occur at other points in the exhaust system 312, such as the points indicated by arrows 344′ (between the two turbochargers) and 344″ (downstream of turbine 318).

Such a system, wherein exhaust gases to be recirculated in an EGR system are introduced at a relatively low pressure point upstream of any precompression of intake air, is sometimes referred to in the art as a “low pressure” EGR system. A suitable flow control device 345 (e.g., valve) may be provided to control the amount of exhaust gases extracted from exhaust system 312 and, thereby, vary the proportion of exhaust gas and air in the mixture that is compressed and cooled before introduction in the combustion chamber of engine 310. Flow control device 345 may be controlled by a suitable controller (e.g., engine controller 26 in FIG. 1 or a similar controller) in response to a monitored condition such as engine load or engine speed, for example. Subsequent to extraction of exhaust gases at point 344 and before introduction into intake system 326 at point 346, the hot exhaust gases may be cooled by a cooler 348. One disclosure of a prior art system involving extraction of exhaust gases from an exhaust system and introduction of the exhaust gases into an air intake system upstream of two stages of compression (low pressure EGR) is described in U.S. Pat. No. 5,617,726 issued to Sheridan et al. The Sheridan et al. patent illustrates, in FIGS. 5-7 thereof, different points of extraction of exhaust gases. The Sheridan et al. patent also discloses that the extracted exhaust gases may be passed through a cooler (19) before being introduced into the intake system for the engine (1). Additionally, after passing through two stages of pressurization (8, 6), the air and exhaust gas mixture passes through a cooler (17) in Sheridan et al.

Referring still to FIG. 6, another expedient that may be employed in the interest of fuel efficiency and enhanced combustion is represented diagrammatically by the arrow 350. As has been discussed in connection with the description of engine cylinder 219 of FIG. 4, fuel may be admitted to the cylinders of engine 310 by way of one or more injectors (such as fuel injector assembly 240 in FIG. 4) situated so as to inject fuel directly into the combustion chamber. Alternative, or additionally, fuel may be introduced into intake system 326 at a point upstream of one or more of compressors 316 or 320. For example, fuel may be introduced upstream of compressor 320 at the point designated diagrammatically by arrow 350. As exemplified by the embodiment illustrated in FIG. 6, the expedient of introducing fuel upstream of precompression of the intake air may be employed in combination with the expedient of low pressure EGR, previously discussed. One prior art disclosure of both the introduction of fuel upstream of a compressor for intake air and the use of low pressure EGR is U.S. Pat. No. 5,357,936 to Hitomi et al. The Hitomi et al. patent illustrates (in FIG. 3 of the patent) a fuel injector (56) upstream of the compressor (represented by supercharger (32)), and a low pressure EGR system including EGR cooler (72) and a point of introduction of the low pressure EGR upstream of supercharger (32).

### INDUSTRIAL APPLICABILITY

Power generation system 10 may be used for stationary applications such as, for example, providing electric energy for a building or for providing energy for propelling a vehicle and/or operating systems of a vehicle that require electric energy. For example, power generation system 10 may be used to provide electric energy for a building to power an electric power grid. Power generation system 10 may also be used to provide electric energy and/or mechanical energy for a hybrid vehicle, which may include one or more combustion engines operably associated with one or more transmissions. For example, combustion engine 12 may operate to produce mechanical energy and generator 30 may operate to convert at least a portion of the mechanical energy into electric energy. The electric energy may be used to operate one or more electric motors and/or other electrically-operated vehicles systems. For example, one or more electric motors 32 may be used to provide torque to driving members 34 (e.g., wheels or ground engaging tracks) to propel the vehicle either independently or in combination with torque provided by combustion engine 12 via one or more mechanical transmissions 52 (see, for example, FIG. 2). For a vehicle such as a work machine, for example, a wheel loader or a track-type tractor, one or more electric motors 32, either alone or in combination with one or more mechanical transmissions 52, may be used to propel the vehicle, and electric energy converted by generator 30 and/or the mechanical energy produced by combustion engine 12 may be used to operate work implements via hydraulic actuators and/or hydraulic motors.

Referring to FIG. 1, for example, electric transmission 28 may be an electric CVT, which may include generator 30 operably coupled one or more electric motors 32. Generator 30 may provide electric energy to power electric motor 32. Generator 30 and electric motor 32 may be in communication via ratio controller 36, which may be configured to control the ratio of transmission output speed to transmission input speed. For example, ratio controller 36 may be configured to adjust the ratio of transmission output speed to transmission input speed, as limited by the actual power output of combustion engine 12. When both output torque and output speed increases are demanded of electric transmission 28 (i.e., in a vehicle application) a demand for increased power may be communicated to combustion engine 12. On the other hand, when both output torque and output speed decreases are desired for electric transmission 28, a demand for decreased power may be communicated to combustion engine 12.

For an exemplary embodiment including a work machine, as the work machine encounters a change in loading conditions due, for example, to changing from a high ground speed combined with a low load situation to a suddenly high load situation, ratio controller 36 may be configured to shift the ratio of electric transmission 28 from a high-speed output to a low-speed output. For an electric transmission, such as, for example, electric transmission 28 shown in FIGS. 1 and 2, the ratio of transmission output speed to transmission input speed at a particular combustion engine output power may be controlled, for example, by manipulating a torque command signal to electric motor 32. As the work machine encounters a change in load conditions due, for example, to changing from a high ground speed with a low load condition to a suddenly high load situation, ratio controller 36 may alter the torque command signal to electric motor 32 to produce additional torque. In turn, the electric motor 32 demands additional electric power from the generator 30 in the form of, for example, additional current.

One or more transmission sensors 40 associated with electric transmission 28 may be configured to provide information relating to its operation. For example, such information may include a torque command signal and/or speed signal from transmission sensor 40 and/or a speed signal from combustion engine sensor 22, which may be used together with the torque command signal to determine a change in torque load of electric transmission 28. The torque command signal from ratio controller 36 to electric motor 32 may be used to measure and/or estimate the output torque of electric motor 32. Other methods of measuring transmission load may be implemented such as, for example, measuring motor input voltage and current, measuring generator output voltage and current, and other methods known to those having ordinary skill in the art.

Referring to FIG. 2, when shifting mechanical transmission 52 from a high-speed output to a low-speed output, for example, ratio controller 58 may be configured to decrease fluid flow supplied to motor 56 by decreasing displacement of pump 54, such that the load on combustion engine 12 is reduced. Ratio controller 58 may also increase displacement of motor 56 in order to decrease the load on combustion engine 12. In this fashion, the ratio of transmission output speed to input speed of a hydraulic transmission (e.g., as shown in FIG. 2) at a particular combustion engine power may be controlled by manipulating the displacement of pump 54 and/or motor 56. As the ratio of mechanical transmission 52 shifts to limit and/or reduce the load on combustion engine 12, the maximum potential ground speed may be reduced. This may result in a drop in work machine ground speed. On the other hand, if the work machine encounters a reduction in load, ratio controller 58 may increase the displacement of pump 54 and/or may decrease the displacement of the motor 56, allowing for an increase in work machine ground speed and a reduction in the torque available to correspond to the reduced load demand on the work machine.

For a mechanical transmission, such as mechanical transmission 52 depicted in FIG. 2, transmission sensor 60 may provide a fluid pressure signal indicative of the load on mechanical transmission 52. For example, transmission controller 38 may be configured to receive inputs from mechanical transmission 52, including a displacement signal from ratio controller 58 and/or a fluid pressure signal from transmission sensor 60. Transmission controller 38 may use the displacement signal and/or fluid pressure signal to calculate a transmission load and/or to determine a change in transmission load.

Engine controller 26 and/or transmission controller 38 may be used, for example, as part of a predictive load management system. Engine controller 26 and/or transmission controller 38 may be embodied in one or more microprocessors. Numerous commercially-available microprocessors may be adapted to perform the functions of engine controller 26 and/or transmission controller 38.

Transmission controller 38 may be configured to transmit a torque command signal to the engine controller 26. Engine controller 26 may be configured to receive input from transmission controller 38 that is indicative of transmission load and/or power load (e.g., output torque and/or power demand). Engine controller 26 may also be configured to receive operating parameters such as, for example, the combustion engine 12's speed from engine sensor 22 and/or the intake pressure signal from pressure sensor 16. Engine controller 26 may also be configured to receive reference parameters, including fuel settings and air delivery requirements. Engine controller 26 may be further configured to process these operating and reference parameters and determine commands to modify performance characteristics of combustion engine 12 during a predictive time period, for example, when a change in load demand is transferred from one or more of the transmissions to combustion engine 12.

The term “predictive time period,” as used herein, is the period of time from when one of the transmissions first experiences a load change on at least one of the driving members 34 until combustion engine 12 experiences the load change. For example, one of the transmissions may experience a change in load on its respective driving member 34. The driving member 34 may transfer the load change to combustion engine 12 via, for example, transmission controller 38 and/or engine controller 26. Combustion engine 12's performance may be modified to accommodate the change in load. The time period associated with such a load transfer is the predictive time period.

Engine controller 26 may be configured to modify performance of combustion engine 12, for example, when engine controller 26 receives information indicating that the load on one or more of the transmissions has changed. For example, engine controller 26 may produce signals to increase or decrease power output of combustion engine 12. In particular, engine controller 26 may adjust the amount of fuel and/or air delivered to intake system 14 or any other aspect of combustion engine 12's operation that may result in a change in the power output.

For example, engine controller 26 may be configured to modify operation of a fuel injection system to vary the power output of combustion engine 12. In particular, engine controller 26 may send a fuel delivery altering signal to adjust the performance of a fuel injection system to control a fuel delivery rate, a fuel delivery timing, a fuel delivery pressure, and/or a fuel torque limit. These fuel delivery altering signals may be produced in accordance with combustion engine control maps such as, for example, fuel rail pressure maps, fuel timing maps, fuel torque limit maps, or other maps known to those having ordinary skill in the art. Alternatively (or in addition), combustion engine 12's performance may be varied to achieve a desired performance using a proportional-integral-differential (PID) control loop. For example, fuel delivery altering signals may be delivered to solenoid-operated fuel injector units associated with individual combustion chambers of combustion engine 12. Duration of the fuel delivery altering signals may correspond to the timing of the solenoid, thereby controlling the duration for which the fuel injector unit delivers fuel to an associated combustion chamber during a combustion cycle. The fuel injector units may be electrically-actuated units, hydraulically-actuated units, mechanically-actuated units, or any other units known to those having ordinary skill in the art.

Engine controller 26 may control the fuel delivery to combustion engine 12 based on a differential between a desired power output required to meet an anticipated load demand change and the current power output. In an exemplary predictive load management system, the fuel delivery to combustion engine 12 may be changed during the predictive time period before the load is transferred from one of the transmissions to combustion engine 12 such that combustion engine 12's power output approaches or achieves the desired power output in preparation for responding to the anticipated change in load demand. As a result, engine controller 26 may change the fuel delivery based on the perceived power output required to either reduce combustion engine 12's under-speed or over-speed condition that may be associated with the anticipated change in load.

Changes in the fuel delivery to combustion engine 12 may be based on a differential between the actual intake pressure and a desired intake pressure required to minimize response time associated with the anticipated load demand change. In an exemplary predictive load management system, fuel delivery to combustion engine 12 may be changed during the predictive time period before the load is transferred from one or more of the transmissions to combustion engine 12 such that the intake pressure approaches or achieves the desired intake pressure in preparation for responding to the anticipated change in load demand. As a result, engine controller 26 may change the fuel delivery based on the perceived intake pressure required to reduce response time associated with the anticipated change in load demand.

In addition, engine controller 26 may produce signals altering air delivery characteristics directly. Air delivery altering signals, which may cause a change in the intake pressure, may be produced in accordance with combustion engine control maps such as, for example, boost maps, wastegate controlling maps, turbo compounding maps, turbo braking maps, and/or other maps known to those having ordinary skill in the art.

Engine controller 26 may be configured to deliver air delivery command signals so that the intake pressure may be changed. The intake pressure may be changed by, for example, a turbo compounding system, a turbo braking system, an exhaust gas wastegating system, and/or other systems known to those having ordinary skill in the art. For example, in some exemplary predictive load management systems, air delivery to combustion engine 12 may be changed during the predictive time period before the load is transferred from one or more of the transmissions to combustion engine 12 such that the intake pressure approaches or achieves the desired air delivery level in preparation for responding to the predicted change in load demand. As a result, engine controller 26 may change the intake pressure based on the perceived pressure differential required to minimize response time associated with the anticipated change in load.

Turbocharger system 48 may be at least a portion of a turbocharger compounding system. The turbocharger compounding system may be used, for example, to increase intake pressure when the flow of exhaust from combustion engine 12 is relatively low. For example, when a load demand is placed on combustion engine 12 to respond to an increased load on power generation system 10, additional fuel may be delivered to combustion engine 12. In order to maintain an AFR consistent with efficient combustion and/or low exhaust emissions, it may be desirable to increase the supply of air to intake system 14. Turbocharger system 48's electric machine 46 may provide supplemental torque to turbocharger 24's compressor, thereby reducing any inherent lag in turbocharger 24's responsiveness to provide an increased supply of air to intake system 14. For example, electric energy may be supplied to electric machine 46 via energy storage device 44 and/or via an integrated starter generator. As a result, turbocharger 24 may supply sufficient air to intake system 14 to correspond to the increase in fuel supplied to intake system 14 in order to substantially maintain an AFR consistent with efficient and/or low exhaust emission operation in a more responsive manner. This may result in increased responsiveness to an increase in load demand on power generation system 10.

Turbocharger system 48 may include a turbo braking system configured to apply a resistance and/or load to turbocharger 24's compressor rotation. For example, when power generation system 10 is exposed to a demand for less power, turbocharger 24's inherent inertia may prevent it from reducing its compressor's rotational speed in a sufficiently responsive manner such that turbocharger 24 provides excessive intake pressure for the reduced power demand. Electric turbocharger 24's electric machine 46 may include a generator that may effectively act as a turbo braking system by activating such that mechanical energy associated with turbocharger 24's rotation may be converted into electric energy by electric machine 46's generator. In particular, torque used to drive electric machine 46's generator may act to reduce the rotational speed of turbocharger 24's compressor, and the converted electric energy may be stored in energy storage device 44. By virtue of increasing the responsiveness of the compressor's decrease in rotational speed, pressure in intake system 14 may be more quickly reduced, which may result in more efficient operation of combustion engine 12 and/or reduced exhaust emissions from combustion engine 12 due, for example, to an improved ability to maintain a desired AFR.

Turbocharger system 48 may include a turbocharger wastegating system configured to exhaust combustion gases to the atmosphere before reaching turbocharger 24's turbine. This may act to more quickly reduce the turbocharger 24's rotation, which may serve to improve the response time of combustion engine 12 to reductions in load by more quickly reducing pressure in intake system 14, which, in turn, may result in more efficient operation and/or reduced exhaust emissions from combustion engine 12.

During operation of exemplary predictive load management system, activation may begin once a load has been placed on one of the transmissions. For example, when transmission controller 38 determines that electric transmission 28 and/or mechanical transmission 52 experiences a load (e.g., a torque load), transmission controller 38 determines a difference in magnitude between a sensed load and a previous torque output of electric transmission 28 and/or mechanical transmission 52. Once a difference has been determined, the sensed load may become the previous torque output for a subsequent operational cycle of the predictive load management system. Transmission controller 38 may compare the magnitude of the determined difference to a predetermined value. If the magnitude of the determined difference is less than the predetermined value, no changes to the performance of combustion engine 12 may be made, and transmission controller 38 may continue to receive signals of the sensed load on electric transmission 28 and/or mechanical transmission 52. Acceptable values for the predetermined value of the magnitude of the difference of demand load changes that result in acceptable speed changes may be determined by lab and/or field-testing.

If, however, the magnitude of the determined difference is equal to or greater than the predetermined value, transmission controller 38 may provide an indication of load change to engine controller 26, which may determine a change in a performance characteristic of combustion engine 12 required to meet an anticipated load change. For example, engine controller 26 may modify fuel delivery and/or intake pressure to offset the anticipated load change in order to substantially minimize occurrences of an under-speed and/or over-speed condition of combustion engine 12 due to sudden changes in load.

For example, engine controller 26 may modify a fuel injection system output to increase or decrease power output of combustion engine 12. Engine controller 26 may, for example, determine a modified fuel torque limit, a modified fuel timing, and/or a modified fuel injection system rail pressure based on the load condition of electric transmission 28 and/or mechanical transmission 52, a desired speed of combustion engine 12, and/or an intake pressure. For example, engine controller 26 may then output a signal indicating an amount of fuel to be delivered to combustion engine 12 in response to a difference between the current speed of combustion engine 12 and intake pressure, and a desired speed of combustion engine 12 and a desired intake pressure.

Engine controller 26 may also be configured to alter air delivery, for example, to change the power output of combustion engine 12. Engine controller 26 may determine a desired intake pressure value based on a load condition of electric transmission 28 and/or mechanical transmission 52 and an anticipated affect of the transmission load on combustion engine 12's performance. For an increase in load, engine controller 26 may determine an increase in intake pressure desired for supplying enough air for efficient combustion of an increasing fuel supply that may accompany the anticipated increase in load. Engine controller 26 may then cause additional energy to be directed to turbocharger 24, for example, by providing a desired output signal 18 to transmission controller 38, which may in turn activate and/or increase output of electric machine 46's electric motor to supplement turbocharger 24's turbine, thereby increasing the intake pressure and associated air delivery to combustion engine 12. This may provide additional air to intake system 14 in order to substantially maintain a desired AFR, such that additional fuel supplied to intake system 14 has sufficient air to combust efficiently and/or with reduced exhaust emissions.

For a decrease in load on one or more of the transmissions, engine controller 26 may determine an amount of decrease in intake pressure and an associated air delivery that will allow for efficient combustion of a decreasing fuel supply that may accompany the anticipated decrease in load. Engine controller 26 may then cause energy to be directed to turbocharger system 48 such that turbocharger 24's rotation is slowed, thereby reducing associated air delivery to intake system 14. This may be accomplished via at least one of turbo braking, wastegating, and activation of electric machine 46's generator. For example, engine controller 26 may send desired output signal 18 to transmission controller 38, which may, in turn, be sent to engine controller 26 to activate electric machine 46's generator to reduce the speed of turbocharger 24's turbine, thereby decreasing the intake pressure and associated air delivery to combustion engine 12. Electric energy converted by electric machine 46's generator may be stored by energy storage device 44. This may result in a reduced amount air being provided to intake system 14 to correspond to a reduced amount of fuel supplied to intake system 14, such that combustion engine 12 operates efficiently and/or with reduced exhaust emissions.

As combustion engine 12's performance changes in response to engine controller 26 and/or load demands, the predictive load management system may continue cycling as electric transmission 28 and/or mechanical transmission 52 experience changes in load. Based on information provided by the transmission sensors 40 and/or 60, for example, the exemplary predictive load management system may operate to reduce response time associated with a change in load on electric transmission 28 and/or mechanical transmission 52, for example, to minimize combustion engine 12's under-speed or over-speed condition. In particular, transmission sensors 40 and/or 60 may be configured to detect a change in load that, under normal circumstances, might result in combustion engine 12 operating outside of a desired operating range, which may result in combustion inefficiencies, higher than desired exhaust emissions, and/or unstable operation. For example, the predictive load management system may serve to modify combustion engine 12's speed just prior to an anticipated load change experienced by the one or more transmissions, and may act to minimize an under-speed or over-speed condition that combustion engine 12 might otherwise exhibit. In addition (or alternatively), turbocharger system 48 may act to change intake system 14's characteristics just prior to an anticipated load, which may allow combustion engine 12 to respond more quickly to the changing load.

During operation, electric transmission 28 and/or mechanical transmission 52 may experience a sudden change in load, such as a demand for more or less torque. Because the transmission(s) experience load changes prior to combustion engine 12, transmission controller 38 may have sufficient time to alert engine controller 26 of the approaching change in load demand, thereby allowing engine controller 26 to respond to the change in transmission load demand prior to combustion engine 12's exposure to the change in load.

For example, electric transmission 28 may sense via transmission sensor 40 an increased motor command torque and may compare that sensed motor command torque to a reference torque value such that a change in load on electric transmission 28 may be indicated. For mechanical transmission 52 (e.g., a hydraulic continuously variable transmission), transmission controller 38 may detect an increase in load by sensing an increase in fluid pressure, for example, via sensor 60, within mechanical transmission 52 and may compare the sensed pressure along with a motor displacement with reference pressure and motor displacement values.

Transmission controller 38 may determine, for example, the magnitude of the increase in load and communicate an anticipated load to engine controller 26. Engine controller 26 may thereafter determine a preparatory action and communicate the preparatory action to combustion engine 12. Such preparatory action for an increased load may include increasing the fuel delivery rate, advancing the fuel delivery timing, increasing the fuel injection pressure, increasing the maximum fuel torque setting, and/or increasing intake system air pressure via turbocharger system 48, all of which may result in an increase in the output of combustion engine 12. Such an increase in the output of combustion engine 12 may function to offset and/or to minimize a predicted under-speed condition. An increase in intake pressure may effectively increase air delivery, which may provide combustion engine 12 with sufficient air for efficient combustion and may permit combustion engine 12 to respond more quickly to an anticipated demand for increased output power. An increase in air delivery may also serve to maintain a desired AFR such that combustion engine 12 operates more efficiently and/or with reduced exhaust emissions.

An anticipated decrease in load on one or more of the transmissions, for example, as sensed by transmission sensor 40 and/or transmission sensor 60, may be communicated to transmission controller 38. Transmission controller 38 may determine a load decrease and may communicate the load decrease to engine controller 26, which may thereafter determine and communicate preparatory commands to combustion engine 12. These preparatory commands may include decreasing the fuel delivery rate, retarding fuel delivery timing, decreasing fuel injection pressure, decreasing the maximum fuel torque setting, and/or decreasing intake air pressure. One or more of these preparatory commands may serve to decrease power output of combustion engine 12. A decrease in power output may function to offset and/or minimize a predicted over-speed condition of combustion engine 12. For example, a decrease in intake air pressure may result in a decrease in an associated air delivery, thereby providing combustion engine 12 with the ability to respond more quickly to a demand for decreased airflow. Intake air pressure and/or an associated air delivery may be reduced via turbocharger braking (e.g., via a generator of electric machine 46) and/or wastegating.

Fuel efficiency, emissions control, and power output may be effectively managed and balanced by employing the turbocharger controller, described in connection with FIGS. 1-3, in an engine that also employs variable late closing Miller Cycle features along with low pressure EGR and multi-stage fuel injection and/or compressing and cooling a fuel/air mixture prior to capturing the fuel/air mixture in an engine cylinder. In one exemplary embodiment, fuel may be admitted (e.g., injected) into the intake air upstream of one or more turbocharger compressors to form a fuel/air mixture which is pressurized and cooled to form a pressurized, temperature-controlled fuel/air mixture. This fuel/air mixture may then be introduced through an inlet port into the combustion chamber of an engine cylinder for combustion during one or more (e.g., each) four-stroke engine cycles, including four-stroke engine cycles such as those shown in FIG. 5 that involve an intake valve being open during a majority portion of the compression stroke and closing very late in the compression stroke.

In another exemplary embodiment, exhaust gases may be controllably extracted from the exhaust system and introduced at a point upstream of one or more turbocharger compressors to form an air/exhaust gas mixture which is pressurized and cooled prior to being introduced via one or more inlet ports into the combustion chamber of an engine cylinder for combustion during one or more four-stroke engine cycles, including those involving the intake valve remaining open during a majority portion of the compression stroke and closing very late in the compression stroke.

Thus, it will be appreciated that the disclosed systems, steps, and apparatus provide a great deal of flexibility to control an engine having a turbocharger controller. This control enables the advantages of the turbocharger controller, with the added capability, where desired, to keep the engine within set limits of performance or other requirements. Furthermore, combining the Miller Cycle related feature of maintaining open at least one intake valve during at least a portion of the intake stroke and beyond the end of the intake stroke and into the compression stroke and during a majority portion of the compression stroke with the disclosed turbocharger controller enables further enhancement of engine performance. Moreover, engine performance may be enhanced even further by the addition of one or more of variable intake valve closing, multi-stage fuel injection, dual stage turbocharging, pre-compression of an air/fuel mixture, and low pressure EGR. Additionally, while FIG. 6 illustrates two turbochargers employed to yield two stages of pressurization, it will be understood that more than two stages of pressurization are contemplated to be within the scope of this disclosure. For example, three stages of turbocharging and pressurization of intake air may offer even greater flexibility and control. One prior art example of the use of three stages of turbocharging is disclosed in U.S. Pat. No. 4,930,315 issued to Kanesaka. See, for example, FIG. 7 of the Kanesaka patent.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A system for controlling intake pressure of a combustion engine operably coupled to a power generation system, the system comprising:
at least one turbocharger operably coupled to an intake system of the combustion engine, the at least one turbocharger being configured to increase the intake pressure in the intake system of the combustion engine; and
a turbocharger controller configured to compare actual and desired intake pressures and to control operation of the at least one turbocharger based on the comparison such that the at least one turbocharger supplies a desired intake pressure to the combustion engine.

2. The system of claim 1, wherein the turbocharger controller includes a comparator configured to output an intake pressure error based on a difference between the desired intake pressure and the actual intake system.

3. An engine comprising:
the system of claim 1;
a chamber with an intake port associated therewith;
a piston partially defining the chamber and being movable in a reciprocating manner within a cylinder through cycles, each cycle involving four strokes of the piston and two rotations of a crankshaft, the four strokes including an intake stroke, a compression stroke, an expansion stroke, and an exhaust stroke;
at least one cooler cooling air compressed by the at least one turbocharger and supplying the cooled, pressurized air to the intake port associated with the chamber; and
an intake valve movable to open and close the intake port;
wherein the engine is configured so that the intake valve opens the intake port,
allows cooled, pressurized air to flow through the intake port and into the chamber during the intake stroke,
maintains open the intake port during the intake stroke and beyond the end of the intake stroke and into the compression stroke and during a majority portion of the compression stroke, and
then closes the intake port during travel of the piston to capture in the chamber a cooled, compressed charge comprising the cooled pressurized air.

4. The engine of claim 3, further including a fuel delivery system delivering fuel into the chamber after the cooled compressed charge is captured in the chamber, wherein the engine ignites a mixture of the fuel and air within the chamber.

5. The engine of claim 4, wherein the fuel delivery system supplies pressurized fuel directly to the chamber during a portion of the compression stroke and during a portion of the expansion stroke.

6. The engine of claim 3, further including an exhaust gas recirculation system forming a mixture including air and recirculated exhaust gas, wherein the at least one turbocharger compresses the air and exhaust gas mixture and the at least one cooler cools the air and exhaust gas mixture before supplying the cooled, compressed mixture to the chamber via the intake port.

7. The engine of claim 6, wherein the exhaust gas recirculation system varies the proportion of exhaust gas and air in the mixture in response to at least one monitored condition and cools the recirculated exhaust gas prior to mixing the recirculated exhaust gas and the air.

8. The engine of claim 3, further including a variable intake valve closing system varying timing of the intake valve.

9. The engine of claim 8, wherein the variable intake valve closing system closes the intake valve at a first crank angle during one four stroke cycle of the piston and at a second crank angle during another four stroke cycle of the piston, the first crank angle being different from the second crank angle.

10. The engine of claim 3, wherein the intake port is maintained open for at least 65% of the compression stroke.

11. The engine of claim 3, wherein the intake port is maintained open for at least 80% of the compression stroke.

12. The engine of claim 3, wherein the at least one turbocharger provides a first stage of compression for air and the at least one cooler provides a first stage of cooling, and wherein the engine includes a second stage of compression and a second stage of cooling.

13. The engine of claim 3, wherein the air is compressed outside the chamber to at least 5 atmospheres, and then cooled to a temperature less than or equal to 200 degrees F.

14. The engine of claim 3, wherein the engine is a diesel-fueled, compression ignition engine.

15. The engine of claim 3, wherein the engine is either a gasoline-fueled engine or a natural gas-fueled engine, and wherein the engine is spark ignited.

16. The engine of claim 3, wherein the intake port is maintained open for a majority portion of the compression stroke during high load operation of the engine.

17. A method of maintaining a desired air-to-fuel ratio supplied to a combustion engine operably coupled to a power generation system, the method comprising:
determining a load on the power generation system;
controlling operation of at least one turbocharger via a turbocharger controller based on a comparison of actual and desired engine intake pressures and the load on the power generation system such that the desired air-to-fuel ratio supplied to the combustion engine is substantially maintained.

18. A method of operating a four-stroke, internal combustion engine including a chamber with an intake port associated therewith, and a piston partially defining the chamber and being movable in a reciprocating manner within a cylinder through cycles, each cycle involving four strokes of the piston and two rotations of a crankshaft, the four strokes including an intake stroke, a compression stroke, an expansion stroke, and an exhaust stroke, the method comprising:
maintaining a desired air-to-fuel ratio in accordance with claim 17;
compressing air outside the chamber via the at least one turbocharger;
cooling air outside the chamber;
supplying the cooled, pressurized air to the intake port associated with the chamber;
opening the intake port;
allowing cooled, pressurized air to flow through the intake port and into the chamber during the intake stroke;
maintaining open the intake port during the intake stroke and beyond the end of the intake stroke and into the compression stroke and during a majority portion of the compression stroke; and
after the maintaining, closing the intake port during travel of the piston to capture in the chamber a cooled, compressed charge comprising the cooled pressurized air.

19. The method of claim 18 further including delivering fuel into the chamber after the cooled compressed charge is captured in the chamber, and igniting a mixture of the fuel and air within the chamber.

20. The method of claim 19, further including supplying pressurized fuel directly to the chamber during a portion of the compression stroke and during a portion of the expansion stroke.

21. The method of claim 18, further including forming a mixture including air and recirculated exhaust gas, and compressing and cooling the air and exhaust gas mixture before supplying the cooled, compressed mixture to the chamber via the intake port.

22. The method of claim 21, further including varying the proportion of exhaust gas and air in the mixture in response to at least one monitored condition and cooling the recirculated exhaust gas prior to mixing the recirculated exhaust gas and the air.

23. The method of claim 18, further including varying timing of the intake valve.

24. The method of claim 23 wherein varying the timing includes closing the intake valve at a first crank angle during one four stroke cycle of the piston and at a second crank angle during another four stroke cycle of the piston, the first crank angle being different from the second crank angle.

25. The method of claim 18, wherein the intake port is maintained open for at least 65% of the compression stroke.

26. The method of claim 18, wherein the intake port is maintained open for at least 80% of the compression stroke.

27. The method of claim 18, wherein the compressing includes a first stage of pressurization and a second stage of pressurization, and wherein the cooling includes a first stage of cooling and a second stage of cooling.

28. The method of claim 18, wherein the air is compressed outside the chamber to at least 5 atmospheres, and then cooled to a temperature less than or equal to 200 degrees F.

29. The method of claim 18, wherein the engine is a diesel-fueled, compression ignition engine.

30. The method of claim 18, wherein the engine is either a gasoline-fueled engine or a natural gas-fueled engine, and wherein the engine is spark ignited.

31. The method of claim 18, wherein the intake port is maintained open for a majority portion of the compression stroke during high load operation of the engine.
